(19) United States
(12) Patent Application Publication
(10) Pub. No.: US 2019/0112497 A1
(43) Pub. Date: Apr. 18, 2019

(54) THERMALLY EMISSIVE COATING MATERIAL COMPOSITION, THERMALLY EMISSIVE COATING AND COATING FORMING METHOD

(71) Applicant: HONDA MOTOR CO., LTD., Tokyo (JP)

(72) Inventors: Kazutaka YOKOYAMA, Wako-shi (JP); Ryosuke KODAIRA, Wako-shi (JP); Kosuke DATEKI, Wako-shi (JP); Takanori KOBAYASHI, Wako-shi (JP)

(21) Appl. No.: 16/155,169

(22) Filed: Oct. 9, 2018

(30) Foreign Application Priority Data
Oct. 17, 2017 (JP) 2017-200726

(51) Int. Cl. C09D 161/06; C09D 7/61; C09D 7/80; B32B 15/20; B32B 27/42

(52) U.S. Cl. CPC C09D 161/06; C09D 7/61; C08K 3/013; B32B 15/20; B32B 27/42; C09D 7/80

(57) ABSTRACT

Provided are a thermally emissive coating material composition, a thermally emissive coating and a coating forming method without any thermally emissive filler. Such a thermally emissive coating material composition has a structure in which a straight alkyl with 4 to 16 carbons atoms is bonded to a phenol nucleus of a resol-type phenolic resin via an ether bond. The thermally emissive coating material composition may be formed by dehydrogenative condensation of a resol-type phenolic resin with a linear primary alcohol with 4 to 16 carbon atoms. The thermally emissive coating material composition forms a thermally emissive coating on a surface of a base material.

### TECHNICAL FIELD

The present invention relates to a thermally emissive coating formed on a surface of a base material to promote heat release, a thermally emissive coating material composition included in the thermally emissive coating and a coating forming method therefor.

### BACKGROUND ART

To form a thermally emissive coating on a surface of an apparatus to promote heat release from the apparatus is publicly known. Such a thermally emissive coating generally includes a main material comprised primarily of a resin such as acrylic resin, and a thermally emissive filler included in the main material, the filler being comprised primarily of inorganic particles such as carbon black held in the main material. See (Patent Document 1).

### PRIOR ART DOCUMENT (S)

### Patent Document(S)

Patent Document 1: JP2006-281514A

### SUMMARY OF THE INVENTION

### Task to be Accomplished by the Invention

A thermally emissive coating in the prior art includes a thermally emissive filler as an essential component. This means that it is necessary to select a thermally emissive filler suitable for a main material, prepare the thermally emissive fillers, and disperse the thermally emissive fillers in the main material, and other necessary processes. Some thermally emissive fillers inconveniently promote the deterioration of the main material. If any thermally emissive filler is not used, forming coating would become easier.

The present invention has been made in view of the aforementioned problems of the prior art, and a primary object of the present invention is to provide a thermally emissive coating material composition, a thermally emissive coating and a coating forming method without any thermally emissive filler.

### Means to Accomplish the Task

In order to attain the above object, a first aspect of the present invention provides a thermally emissive coating material composition for forming a thermally emissive coating, wherein the thermally emissive coating material composition has a structure represented by the following chemical formula (1)

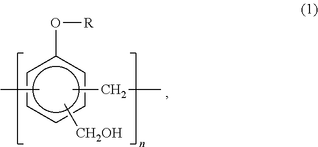

where R is a straight alkyl with 4 to 16 carbon atoms.

This aspect of the present invention makes it possible to provide a thermally emissive coating material composition without any thermally emissive filler. In the composition, a straight alkyl is flexible enough to be capable of having various conformations. Thus, molecular motions including rotational or vibrational motions of a straight alkyl side chain increase the energy consumption therein and also increase contacts between the side chain and external gas molecules and/or liquid molecules, thereby promoting and improving heat release of a thermally emissive coating.

A second aspect of the present invention provides a thermally emissive coating material composition for forming a thermally emissive coating, wherein the thermally emissive coating material composition is formed by dehydrogenative condensation of a resol-type phenolic resin with a linear primary alcohol with 4 to 16 carbon atoms.

This aspect of the present invention makes it possible to provide a thermally emissive coating material composition without any thermally emissive filler. In this case, a straight alkyl side chain can be introduced to a phenolic resin via an ether bond by causing dehydrogenative condensation of a resol-type phenolic resin with a primary alcohol.

Another aspect of the present invention provides a thermally emissive coating comprising the thermally emissive coating material composition of the first or second aspect, and formed on a surface of a base material.

These aspects make it possible to provide a thermally emissive coating without any thermally emissive filler.

In the above aspects, the thermally emissive coating preferably has a thickness of 15 to 50 μm.

This feature can improve the thermal emissivity of the thermally emissive coating. In the thermally emissive coating, most of the heat release occurs via the straight alkyl side chains located in a surface portion of the thermally emissive coating. Thus, the greater the ratio of the surface area to the volume of the thermally emissive coating has, the greater the thermal emissivity thereof becomes.

In the above aspects, the base material preferably includes aluminum.

This feature enables the thermally emissive coating to be adhered to the base material in a stable manner.

In the above aspects, the thermally emissive coating preferably includes a thermally emissive filler formed of inorganic particles in an amount of 0.1% by weight or less. Also, preferably, the thermally emissive coating is free of any thermally emissive filler formed of inorganic particles.

This feature can improve the thermal emissivity of the thermally emissive coating. The thermally emissive fillers located in a surface portion can prevent molecular motions of the straight alkyl side chains, which leads to a decrease in the thermal emissivity of the thermally emissive coating.

Yet another aspect of the present invention provides a coating forming method for forming a thermally emissive coating on a base material comprising: a first step of applying a solution containing a resol-type phenolic resin onto a surface of the base material; a second step of heating the base material, on which the solution containing the resol-type phenolic resin has been applied, at 50° C. to 100° C. subsequent to the first step; a third step of applying a solution containing a linear primary alcohol with 10 to 16 carbon atoms on the base material subsequent to the second step; and a fourth step of heating the base material, on which the solution containing the linear primary alcohol has been applied, at 100° C. to 200° C. subsequent to the third step.

In this aspect of the present invention, a straight alkyl side chain can be introduced to a phenolic resin via an ether bond by causing dehydrogenative condensation of a resol-type phenolic resin with a primary alcohol. Since the method of the this aspect includes forming a phenolic resin coating on a surface of a base material, followed by introducing straight alkyl side chains into a surface portion, the straight alkyl side chains can be effectively distributed in the surface portion of a thermally emissive coating. As a result, the surface of the thermally emissive coating becomes hydrophobic and the ether bond becomes harder to be hydrolyzed, which means that the thermally emissive coating becomes less likely to deteriorate by water.

### Effect of the Invention

As can be appreciated from the foregoing, the present invention can provide a thermally emissive coating material composition, a thermally emissive coating and a coating forming method without any thermally emissive filler.

### BRIEF DESCRIPTION OF THE DRAWINGS

FIG. 1 is a diagram of a test container used for thermal emissivity testing;

FIG. 2A is a graph showing the relationship between heat release time and temperature;

FIG. 2B is a graph showing the relationship between heat release time and temperature difference (ln(Ts−Ta));

FIG. 3 is a graph showing the relationship between the thickness of a thermally emissive coating and the heat release rate ratio;

FIG. 4 is a graph showing the relationship between the number of carbon atoms of a side chain and the heat release rate ratio; and

FIG. 5 is a graph showing the heat release rate ratios of two thermally emissive coatings before and after their water resistance tests, where the two thermally emissive coatings were formed by using first and second coating forming methods, respectively.

### DESCRIPTION OF THE PREFERRED EMBODIMENT(S)

Embodiments of a thermally emissive coating material composition, a thermally emissive coating and a coating forming method therefor according to the present invention are described in the following.

(Thermally Emissive Coating Material Composition)

A thermally emissive coating material composition is a composition included in a thermally emissive coating, and has a structure represented by the following chemical formula (1):

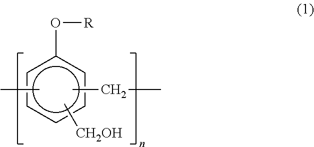

where R is a straight alkyl with 4 to 16 carbon atoms.

The thermally emissive coating material composition has a main chain, a resol-type phenolic resin, and a side chain (R) which is bonded to the phenol nucleus (benzene ring) of the main chain by an ether bond. The main chain may be linked to any of ortho, meta, and para positions of the phenol nucleus. The hydroxymethyl group may be linked to any of ortho, meta, and para positions of the phenol nucleus.

The thermally emissive coating material composition is formed by dehydrogenative condensation of a resol-type phenolic resin having a structure represented by the following chemical formula (2) with a primary alcohol with 4 to 16 carbon atoms:

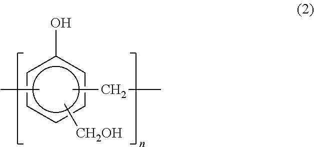

As a result of dehydrogenative condensation of the hydroxyl bound to the phenol nucleus with the hydroxyl of primary alcohol, water is separated from them, an ether bond is formed. The dehydrogenative condensation is carried out, for example, by heating the mixture of the compounds to 130 to 140° C. The dehydrogenative condensation of a resol-type phenolic resin with a primary alcohol can also be carried out by, for example, adding concentrated sulfuric acid to the mixture and then heating it to 130 to 140° C.

The thermally emissive coating material composition is usually in liquid form and soluble in an organic solvent such as alcohols or acetones. Heating the thermally emissive coating material composition causes the hydroxymethyl group and the phenol nucleus to be condensation cross-linked to form a 3D network. In the cross-linked state, the thermally emissive coating material composition is in a solid form and insoluble to an organic solvent.

(Thermally Emissive Coating Material)

A thermally emissive coating material includes the thermally emissive coating material composition as described above and a solvent which dissolves the thermally emissive coating material composition, and is prepared in a liquid form. The solvent is preferably a volatile organic solvent, and non-limiting examples of the solvents include: ketones such as acetone and methyl ethyl ketone; ester acetates such as methyl acetate, ethyl acetate, and propyl acetate; carbon hydrides such as n-hexane, cyclohexane, methylcyclohexane and n-heptane; aromatic hydrocarbons such as toluene, xylene, and benzene; and ethers such as ethyleneglycol monobutyl ether, ethylene glycol monophenyl ether, and ethylene glycol dimethyl ether. The thermally emissive coating material may further contain other ingredients such as pigments, silane coupling agents, pigment dispersants, leveling agents, antifoaming agents, and thickening agents.

(Thermally Emissive Coating)

A thermally emissive coating is a coating formed on a surface of a base material and includes the above-described thermally emissive coating material composition. The base material may be a housing, a tube or a core of a heat exchanger, for example. In this case, the heat exchanger may be, for example, an intercooler or a radiator of a vehicle. The base material is preferably formed of iron, aluminum, or alloys thereof.

In the thermally emissive coating material composition included in the thermally emissive coating, the hydroxymethyl group and the phenol nucleus are condensation cross-linked to form a 3D network. Preferably, the thermally emissive coating has a thickness of 15 μm to 50 μm.

The thermally emissive coating includes a thermally emissive filler formed of inorganic particles in an amount to 0.1% by weight or less. Preferably, the thermally emissive coating is free of any thermally emissive filler formed of inorganic particles. The thermally emissive filler may be formed of particles of a filler material such as carbon black, zinc oxide, aluminum nitride, silicon oxide, calcium fluoride, boron nitride, quartz, kaolin, aluminum hydroxide, bentonite, talc, salicide, forsterite, mica, cordierite, or boron nitride.

The phenolic resin forming the thermally emissive coating has a straight alkyl side chain, which is flexible enough to be capable of having various conformations. Thus, it is considered that molecular motions including rotational or vibrational motions of a side chain increase the energy consumption therein and also increase contacts between the side chain and external gas molecules and/or liquid molecules, thereby improving the thermal emissivity of a thermally emissive coating. The side chain is preferably a straight alkyl due to the ease of molecular motions. It is considered that, when a side change includes a polar group, a double bond, a triple bond or some other types of groups or bonds, molecular motions of the side chain are prevented, leading to a decrease in the thermal emissivity of a thermally emissive coating.

(First Coating Forming Method)

A first coating forming method includes the first step of applying the above-described thermally emissive coating material to a surface of a base material. Methods of applying include spraying, dipping coating, brush coating, roller coating and any other suitable application technique. The first coating forming method further includes the next step of heating the base material with the thermally emissive coating material applied thereon at 160 to 180° C. for 10 to 20 minutes. This step causes the thermally emissive coating material composition to be cross-linked and become in solid form, and allows the solvent to volatilize. As a result, the thermally emissive coating is formed on the surface of base material.

(Second Coating Forming Method)

A second coating forming method includes the first step of applying a phenol solution including the resol-type phenolic resin having the structure represented by the chemical formula (2) dissolved in a solvent to a surface of a base material. The solvent may be the same solvent as one contained in the above-mentioned thermally emissive coating material. A method of coating the phenol solution may be any of the various methods described above. The second coating forming method further includes the second step of heating the base material with the phenol solution applied thereon at 60 to 80° C. for 5 to 15 minutes. This step allows the solvent to volatilize, and causes part of the resol-type phenolic resin to be cross-linked and become in solid form. As a result, a phenolic resin film is formed on the surface of base material.

The second coating forming method further includes the third step of applying a solution of a primary alcohol with 10 to 16 carbon atoms onto the surface of the base material with the phenolic resin film provided thereon. A method of coating the solution may be any of the various methods described above. In the fourth step, the base material on which the primary alcohol solution has been applied is heated to at 160 to 180° C. for 10 to 20 minutes. This heating step causes dehydrogenative condensation of the hydroxyl bonded to the phenol nucleus with the hydroxyl of the primary alcohol so that a straight alkyl side chain binds to the phenol nucleus via an ether bond. This means that the thermally emissive coating material composition having the structure represented by the chemical formula (1) is formed. The heating step also causes the crosslinking of the phenolic resin to proceed further, and allows the solvent to volatilize. As a result, the thermally emissive coating is formed on the surface of base material. A primary alcohol with nine or less carbon atoms is volatile. In this case, the fourth step of heating causes the volatilization to occur more dominantly than the dehydrogenative condensation reaction, thereby preventing the formation of the thermally emissive coating material composition having the structure represented by the chemical formula (1).

Since the second coating forming method includes the step of forming a phenolic resin film on the surface of a base material followed by the step of applying a primary alcohol to the surface of a phenolic resin film, straight alkyl side chains are likely to be distributed in a surface portion of a thermally emissive coating. As a result, the surface of the thermally emissive coating becomes hydrophobic and ether bonds of side chains become harder to be hydrolyzed, which means that the thermally emissive coating becomes less likely to deteriorate by water.

### EXAMPLES

(Example of First Coating Forming Method)

Several thermally emissive coating material compositions were prepared where the compositions have the structure represented by the chemical formula (1) including R with different numbers of carbon atoms. Each thermally emissive coating material composition was diluted with ethyleneglycol monobutyl ether to a concentration of 5% by weight to produce a corresponding thermally emissive coating material. As a substrate (base material), an aluminum plate (A1050, 150 mm length, 70 mm width and 0.8 mm thickness) was used. Each thermally emissive coating material was applied to a major surface of the substrate by air-spraying a proper amount of the thermally emissive coating material onto the surface of the substrate. Then, in a heating oven, the substrate with the applied thermally emissive coating material was heated at 160° C. for 15 minutes. This heating step caused the thermally emissive composition to be cross-linked and become in solid form on the surface of the substrate, and also caused ethyleneglycol monobutyl ether to volatilize, thereby forming a thermally emissive coating on the surface of the substrate. The thickness of a thermally emissive coating measured after heating was determined as the thickness of the thermally emissive coating. The thickness of a thermally emissive coating can be adjusted by the quantity of thermally emissive coating material to be air-sprayed.

(Thermal Emissivity Testing)

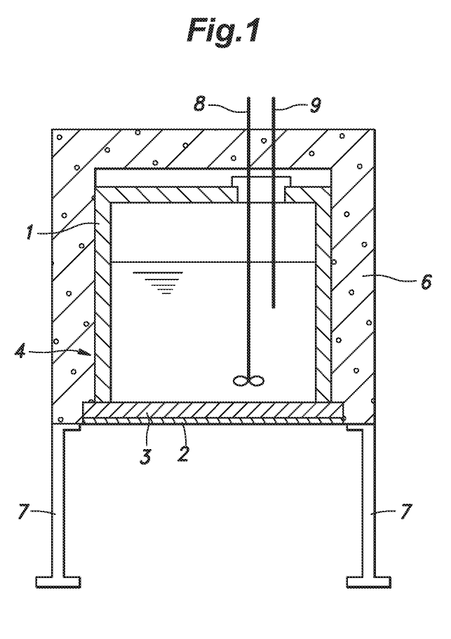

The thermal emissivity of each thermally emissive coating was assessed by the following thermal emissivity testing. As shown in FIG. 1, the bottom portion of a rectangular parallelepiped steel can 1 (130 mm length, 50 mm width, 100 mm height and thickness 0.8 mm) was blocked with a substrate 3 with a thermally emissive coating 2 formed thereon so as to form a test container 4. The substrate 3 was provided such that the surface with the thermally emissive coating 2 faces downward (to the outside). The steel can 1 and the substrate 3 were liquid-tightly bonded to each other with an adhesive. The top and the sides of the test container 4 are covered with foamed polystyrene 6 (heat insulating material) having a thickness of 30 mm. The test container 4 was placed on a container stand 7 with the foamed polystyrene 6 provided therebetween, and the substrate 3 was placed far enough away from those other elements. A liquid inlet is formed at the top of the test container 4. At the beginning of a testing process, 350 mL engine oil heated to 100° C. was injected into the test container 4. The injected engine oil was stirred at 200 rpm with a stir bar 8 which was provided inside the test container. Furthermore, a thermocouple 9 for measuring the temperature of the engine oil was also provided within the test container 4. A thermocouple (not shown) for measuring outside air temperatures is provided outside a measuring apparatus (outside the foamed polystyrene). Measurements were conducted in an environment in which the outside air temperature was at room temperature (about 22° C.), and when the temperature of the injected engine oil dropped from 100° C. to reach 85° C., the time was defined as time zero, from which temperatures of the engine oil were measured and recorded. As a reference, similar thermal emissivity testing (temperature measurements) was conducted using a test container with a bottom without any thermally emissive coating.

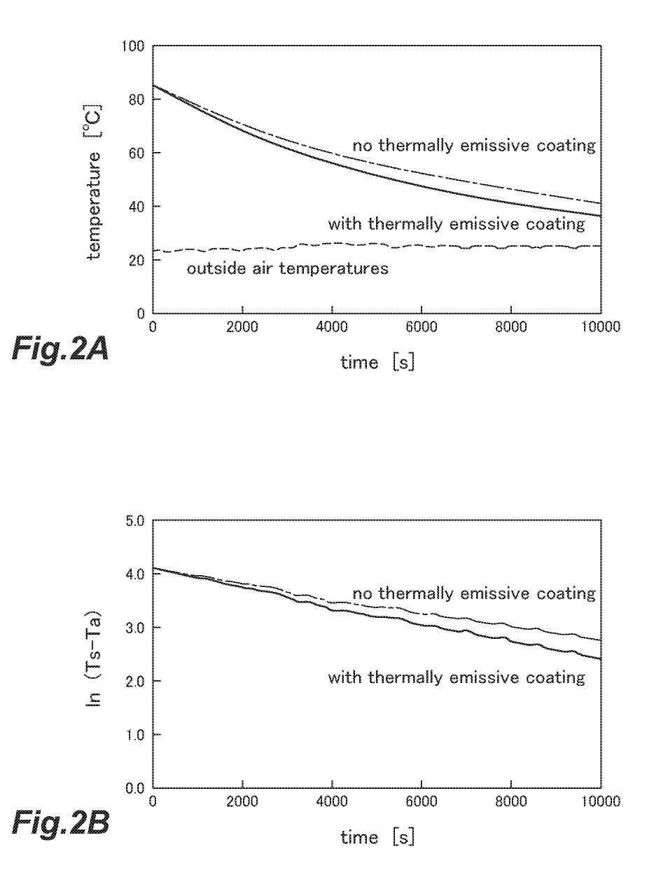

FIGS. 2A and 2B show the obtained results of the thermal emissivity testing. FIGS. 2A and 2B show the results obtained under the conditions in which the used thermally emissive coating material composition had a structure represented by the chemical formula (1) including an R with 16 carbon atoms and the thickness of the thermally emissive coating was 20 μm. FIG. 2A shows a graph including a horizontal axis represents time [s] and a vertical axis represents temperatures [° C.]. The temperature of engine oil decreases due to heat release via the substrate as time proceeds. FIG. 2B shows a graph showing the converted results shown in FIG. 2A, and in the graph of FIG. 2B, a horizontal axis represents time [s] and a vertical axis represents (ln (Ts−Ta); that is, the natural log of value obtained by subtracting a corresponding outside air temperature Ta from an engine oil temperature Ts. As can be seen in FIGS. 2A and 2B, it was confirmed that, when the bottom substrate was provided with the thermally emissive coating, the gradient in the graph was larger compared to the case of the bottom substrate without the thermally emissive coating (reference testing). Here, the gradient in the graph in FIG. 2B, that is, the amount of change of ln (Ts−Ta) per unit time (is) is defined as a heat release rate Vs, Vr. Vs represents a heat release rate for the substrate provided with the thermally emissive coating and Vr represents a heat release rate for the substrate without a thermally emissive coating. The ratio of a heat release rate Vs to a heat release rate Vr (reference testing) is defined as a heat release rate ratio R (=(Vs−Vr)/Vr×100).

(Effect of Coating Thickness on Thermal Emissivity)

For the first thermally emissive coating forming method, the thermally emissive coating material composition having a structure represented by the chemical formula (1) including an R with 12 carbon atoms was used to prepare several thermally emissive coatings having different thicknesses by spraying different quantities of the thermally emissive coating material onto substrates. The thicknesses of the formed thermally emissive coatings were 17 μm, 30 μm, 48 μm, and 60 μm. The thermal emissivity testing was conducted on each of the substrates with the respective thermally emissive coatings having their different thicknesses.

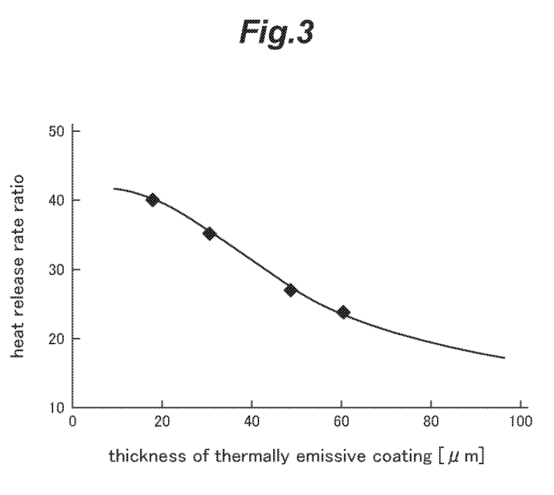

FIG. 3 shows a graph showing the relationship between the thickness and the heat release rate ratio of a thermally emissive coating. From the results shown in FIG. 3, it was confirmed that, as the thickness of the thermally emissive coating increased, the heat release rate ratio decreased. It was also confirmed that the heat release rate ratio varied little when the thickness of the thermally emissive coating was in the range above 60 μm. In the case of the thermally emissive coating of this example, it was difficult to form a uniform coating when the thickness of the coating was 10 μm or less. Also, the thermally emissive coating desirably has a thickness of at least 10 μm since the heat release rate ratio becomes zero when the thickness of the thermally emissive coating is zero. Preferably, the thickness of the thermally emissive coating is 15 to 50 μm. Since, within this thickness range, the thermal emissivity increases as the film thickness is thinner, the thickness of the thermally emissive coating is more preferably 15 to 40 μm, and further more preferably 15 to 30 μm. The thinner the thermally emissive coating is, the greater the ratio of the surface area to the volume of the thermally emissive coating is, which means more straight alkyl side chains are placed in the surface of the thermally emissive coating with regard to the volume. It is considered that this is how an increase in the thermal emissivity occurs.

(Effect of Side Chain on Thermal Emissivity)

In the first thermally emissive coating forming method, different thermally emissive coating material compositions having the structure represented by the chemical formula (1) including an R with different numbers of carbon atoms; that is, straight alkyls with 4, 12, and 16 carbon atoms were used to prepare respective thermally emissive coatings each having a thickness of 20 μm. The thermal emissivity testing was conducted on each of the substrates with the respective thermally emissive coatings.

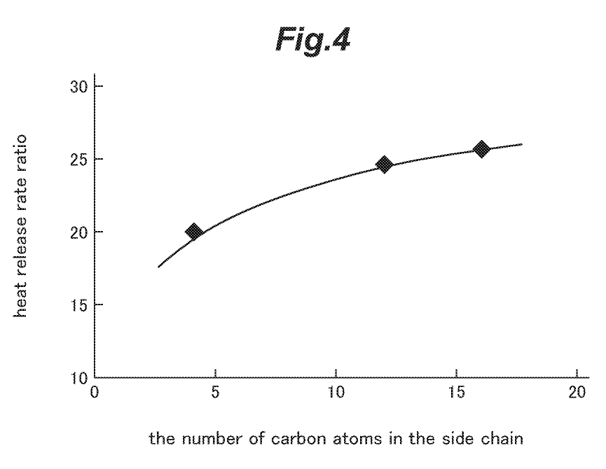

FIG. 4 shows a graph showing the relationship between the number of carbon atoms of a side chain and the heat release rate ratio of a thermally emissive coating. From the results shown in FIG. 4, it was confirmed that, as the number of carbon atoms of a straight alkyl (i.e., the length of a side chain) of the thermally emissive coating increased, the heat release rate ratio increased. It was also confirmed that the heat release rate ratio varied little when the number of carbon atoms of a straight alkyl was four or less. In the case of the thermally emissive coating material composition of this example, it was difficult to create a thermally emissive coating material composition having a side chain with 17 or more carbon atoms by dehydrogenative condensation reaction of a resol type phenol with a primary alcohol. This difficulty arose because linear primary alcohols having 17 or more carbon atoms are in solid form. Thus, the number of carbon atoms of R of a thermally emissive coating material composition having the structure represented by the chemical formula (1) is preferably 4 to 16. When the number of carbon atoms of R is in the range of 16 or less, the greater the number of carbon atoms of R is, the greater the thermal emissivity becomes. Thus, the number of carbon atoms of R is more preferably 8 to 16, and further more preferably 10 to 16. As the number of carbon atoms of a side chain increases, the side chain becomes more flexible, thereby allowing easy molecular motions of the side chain. It is considered that the easy molecular motion of the side chain increases the energy consumption therein and promotes contacts between the side chain and external gas molecules, thereby increasing the thermal emissivity.

(Effect of Thermally Emissive Filler on Thermal Emissivity of Thermally Emissive Coating)

In the first thermally emissive coating forming method, the thermally emissive coating material composition having the structure represented by the chemical formula (1) including an R with 12 carbon atoms was used to prepare a thermally emissive coating material of this example. In addition, a thermally emissive coating material of a comparative example was prepared by suspending carbon black (particle size 3 μm) as a thermally emissive filler at a concentration of 0.5% by weight. The thermally emissive coating material of the comparative example was the same as the thermally emissive coating material of the example except that it included a thermally emissive filler. The thermally emissive coating materials of the example and the comparative example were used to prepare respective thermally emissive coatings both having a thickness of 50 μm. The thermal emissivity testing was conducted on each of the substrates with the thermally emissive coatings of the example and the comparative example, respectively.

The results of thermal emissivity testing showed that the heat release rate ratio of the thermally emissive coating (without any thermally emissive filler) of the example was 31, whereas the heat release rate ratio of the thermally emissive coating (with the thermally emissive filler) of the comparative example was 20. Thus, it was confirmed that the thermally emissive coating without the thermally emissive filler had a higher thermal emissivity. It is considered that the density of straight alkyl side chains in a surface portion of the thermally emissive coating decreased due to the exposure of the thermally emissive filler to the surface. It is also considered that the thermally emissive filler prevented molecular motions of side chains consisting of a straight alkyl in the surface portion of the thermally emissive coating. As a result, the thermally emissive coating without any thermally emissive filler exhibited the increased thermal emissivity compared to the thermally emissive coating including the thermally emissive filler.

(Example of Second Coating Forming Method)

A resol-type phenolic resin having a structure represented by the chemical formula (2) was diluted with ethyleneglycol monobutyl ether to a concentration of 5% by weight to produce a phenol solution. As a substrate (base material), an aluminum plate (A1050, 150 mm length, 70 mm width and 0.8 mm thickness) was used. The phenol solution was applied onto one of the major surfaces of the substrate by air-spraying a proper amount of phenol solution onto the surface (First step). Then, in a heating oven, the substrate with the phenol solution applied thereon was heated at 60° C. for five minutes (Second step). This heating step caused ethyleneglycol monobutyl ether to volatilize, and also caused part of the resol-type phenolic resin to be cross-linked, thereby forming a phenolic resin coating on the surface of the substrate. Subsequently, a linear primary alcohol with 12 carbon atoms was air-sprayed onto the surface of the phenolic resin (Third step). Then, the substrate was heated at 160° C. for 15 minutes (Fourth step). This heating step caused dehydrogenative condensation of the hydroxyl bonded to the phenol nucleus with the hydroxyl of the primary alcohol so that a straight alkyl side chain bound to the phenol nucleus via an ether bond, to thereby form a thermally emissive coating consisting of the thermally emissive coating material composition having the structure represented by the chemical formula (1) on the surface of the substrate.

(Effect of Thermally Emissive Coating Forming Method on Water Resistance)

The first and second thermally emissive coating forming methods were used to form respective thermally emissive coatings having a thickness of 20 μm and consisting of the composition having the structure represented by the chemical formula (1) including an R with 12 carbon atoms. Water resistance tests were conducted on the thermally emissive coatings formed by the different methods, respectively. The water resistance tests were conducted by immersing the substrates with the respective thermally emissive coatings for 24 hours in water at 20° C. After the water resistance test, each substrate was dried by air drying. The water resistance levels of the thermally emissive coating on the substrates were assessed by measuring the heat release rate ratios of the thermally emissive coating before and after the respective water resistance tests. The heat release rate ratios were measured by the thermal emissivity testing described above.

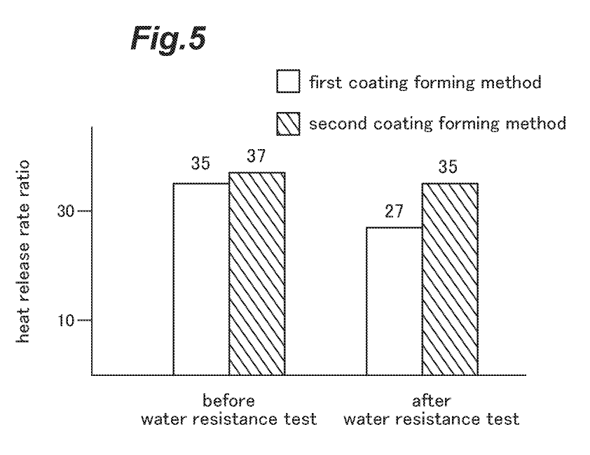

FIG. 5 is a graph showing the heat release rate ratios of two thermally emissive coatings before and after their water resistance tests, where the two thermally emissive coatings were formed by the first and second coating forming methods, respectively. Both the thermally emissive coatings formed by the first and second coating forming methods exhibited similar levels of thermal emissivity before the water resistance tests. However, after the water resistance tests, in the case of the thermally emissive coating formed by the second coating forming method, the heat release rate ratio of the coating little changed from before the water resistance test, whereas, in the case of the thermally emissive coating formed by the first coating forming method, the heat release rate ratio of the coating decreased compared to that before water resistance test. It is considered that the decrease in the heat release rate ratio of the thermally emissive coating formed by the first coating forming method after the water resistance test was caused by hydrolysis of the ether bond of the coating material. It is considered that the thermal emissivity decreased because the side chain of the composition, which caused an increase in the thermal emissivity, separated from the phenol nucleus through hydrolysis of the ether bond. Since the second coating forming method includes the step of forming a phenolic resin film followed by the step of applying a liner primary alcohol onto the surface of the phenolic resin film, the straight alkyl side chains are likely to be distributed in a surface portion of the thermally emissive coating. It is considered that, as a result of this distribution of the straight alkyl side chains, the surface of thermally emissive coating became hydrophobic, which means that water became less able to be close to the ether bond and thus the ether bond became harder to be hydrolyzed.

### GLOSSARY

1 steel can
2 thermally emissive coating
3 substrate
4 test container
6 foamed polystyrene
7 container stand
8 stir bar
9 thermocouple

1. A thermally emissive coating material composition for forming a thermally emissive coating, wherein the thermally emissive coating material composition has a structure represented by the following chemical formula (1) 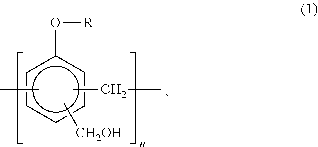
where R is a straight alkyl with 4 to 16 carbon atoms.

2. A thermally emissive coating material composition for forming a thermally emissive coating, wherein the thermally emissive coating material composition is formed by dehydrogenative condensation of a resol-type phenolic resin with a linear primary alcohol with 4 to 16 carbon atoms.

3. A thermally emissive coating comprising the thermally emissive coating material composition according to claim 1, and formed on a surface of a base material.

4. The thermally emissive coating according to claim 3, wherein the thermally emissive coating has a thickness of 15 to 50 μm.

5. The thermally emissive coating according to claim 3, wherein the base material includes aluminum.

6. The thermally emissive coating according to claim 3, wherein the thermally emissive coating comprises a thermally emissive filler formed of inorganic particles in an amount of 0.1% by weight or less.

7. The thermally emissive coating according to claim 3, wherein the thermally emissive coating is free of any thermally emissive filler formed of inorganic particles.

8. A coating forming method for forming a thermally emissive coating on a base material comprising:
a first step of applying a solution containing a resol-type phenolic resin onto a surface of the base material;
a second step of heating the base material, on which the solution containing the resol-type phenolic resin has been applied, at 50° C. to 100° C. subsequent to the first step;
a third step of applying a solution containing a linear primary alcohol with 10 to 16 carbon atoms on the base material subsequent to the second step; and
a fourth step of heating the base material, on which the solution containing the linear primary alcohol has been applied, at 100° C. to 200° C. subsequent to the third step.
